(19) United States
(12) Patent Application Publication
(10) Pub. No.: US 2008/0218716 A1
(43) Pub. Date: Sep. 11, 2008

(54) METHOD FOR SETTING AN OPTICAL IMAGING PROPERTY IN A MICROLITHOGRAPHIC PROJECTION EXPOSURE APPARATUS, AND PROJECTION EXPOSURE APPARATUS OF THIS TYPE

(75) Inventors: Stephan Back, Langenau (DE); Guido Soyez, Ludwigsburg (DE); Joachim Buechele, Westhausen (DE); Annette Muehlpfordt, Aalen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/044,743

(22) Filed: Mar. 7, 2008

Related U.S. Application Data
(63) Continuation of application No. PCT/EP2006/008328, filed on Aug. 25, 2006.
(60) Provisional application No. 60/716,397, filed on Sep. 13, 2005.

(51) Int. Cl. G03B 27/42

(52) U.S. Cl. 355/53; 355/77

(57) ABSTRACT

In some embodiments, the disclosure provides a method for setting an optical imaging property in a microlithographic projection exposure apparatus via which a mask can be imaged onto a substrate having a light-sensitive surface, wherein the substrate can be moved stepwise in a direction transversely with respect to an optical axis relative to a projection objective. The method can include introducing an immersion medium under a predetermined pressure and/or with a predetermined flow rate into at least one first interspace, wherein the at least one first interspace—as seen along the optical axis—is arranged within an illumination system and/or the projection objective and/or between the illumination system and the mask and/or the mask and the projection objective and/or the projection objective and the substrate. The method can also include monitoring an actual pressure and/or an actual flow rate of the immersion medium for deviation from the predetermined pressure and/or the predetermined flow rate.

### CROSS-REFERENCE TO RELATED APPLICATIONS

The present application is a continuation of pending International patent application PCT/EP2006/008328 filed on Aug. 25, 2006, which claims priority of U.S. provisional patent application No. 60/716,397 filed on Sep. 13, 2005. The contents of International patent application PCT/EP2006/008328 are hereby incorporated by reference.

### FIELD

The disclosure relates to a method for setting an optical imaging property in a microlithographic projection exposure apparatus. The disclosure also relates to a microlithographic projection exposure apparatus of this type.

### BACKGROUND

A microlithographic projection exposure apparatus is used during the production of, for example, electronic components, such as integrated circuits. In a microlithographic production method, a mask, which is usually also referred to as a reticle, and which has a structure to be imaged, is imaged onto a substrate, which is usually also referred to as a wafer, via the projection objective. The substrate has a light-sensitive surface, usually a photoresist, which is exposed in accordance with the pattern of the mask. After the photoresist has been developed, the desired structure arises in the substrate.

During an exposure process, the entire surface of the substrate is usually not exposed. Rather only an area section of the substrate is usually exposed at a given time. Therefore, the substrate is typically moved from time to time, that is to say stepwise, relative to an optical axis of the projection objective in order to progressively expose the entire surface of the substrate. For this purpose, the substrate is commonly arranged on a table that can be moved stepwise, for example via a stepper motor.

The increasing integration density of the electronic components that are to be produced microlithographically is also accompanied by an increase in the desired charactertistics of the resolution capability of the projection objective of a projection exposure apparatus of this type. An increase in the numerical aperture of the system generally leads to an improvement in the resolution capability.

### SUMMARY

In some embodiments, the disclosure provides a method for setting an optical imaging property in a microlithographic projection exposure apparatus with which imaging aberrations caused by the stepwise movement of the substrate relative to the projection objective can be counteracted as effectively as possible.

In certain embodiments, the disclosure provides a microlithographic projection exposure apparatus in which imaging aberrations on account of the stepwise movement of the substrate relative to the projection objective are as far as possible avoided or at least reduced.

A first aspect of the disclosure provides a method for setting an optical imaging property in a microlithographic projection exposure apparatus by which a mask can be imaged onto a substrate having a light-sensitive surface, wherein the substrate can be moved stepwise in a direction transversely with respect to an optical axis relative to a projection objective, including the steps of:
introducing an immersion medium under a predetermined pressure and/or with a predetermined flow rate into at least one first interspace, wherein the at least one first interspace—as seen along the optical axis—is arranged within an illumination system and/or the projection objective and/or between the illumination system and the mask and/or the mask and the projection objective and/or the projection objective and the substrate, and
monitoring an actual pressure and/or an actual flow rate of the immersion liquid for deviations from the predetermined pressure and/or the predetermined flow rate.

It is desirable that the at least one first interspace—as seen along the optical axis—can be arranged within the entire projection microlithography apparatus. Not only immersion liquids but also immersion gases, and also a combination of immersion gas and immersion liquid, and a combination of different immersion liquids and/or different immersion gases, can be provided as the immersion medium.

Provision is made for providing alongside one first interspace also further interspaces in the projection microlithography apparatus, in a manner arranged along the optical axis, wherein the interspaces can have different geometries. In this case, the form of the interspace can advantageously be adapted to the form of a respective adjoining optical component of the illumination system and/or of the projection objective.

The interspaces can be arranged—as seen along the optical axis—both above and below the optical component, and above one optical component and below a further optical component arranged at a distance from the first optical component.

It is possible that the interspaces to adjoining optical components can be filled from both sides with the same or different immersion media. For this purpose, the constitution of the respective surfaces of the respective optical component is desirably coordinated with this.

Flushing the interspaces with different immersion media can involve, for example, that the individual interspaces be hermetically sealed. Each interspace can be filled via a separate immersion media flushing circuit—flushing circuit for short—each having an inlet and an outlet. The flushing circuits can be controlled and regulated separately from one another, but it is also possible for different flushing circuits to be controlled and regulated in a manner dependent on one another.

A further aspect of the disclosure provides a microlithographic projection exposure apparatus for imaging a mask onto a substrate having a light-sensitive surface, including a projection objective, a table, on which can be arranged the substrate with the light-sensitive surface facing an end face of the projection objective, including a stepper drive for the stepwise movement of the table in a direction transversely with respect to an optical axis of the projection objective, including at least one first interspace, wherein the at least one first interspace, into which an immersion medium can be introduced, can be arranged—as seen along the optical axis—within an illumination system and/or the projection objective and/or between the illumination system and the mask and/or the mask and the projection objective and/or the projection objective and the substrate, wherein at least one monitoring device is provided for monitoring an actual pressure and/or an actual flow rate of the immersion medium in the at least one first interspace.

The method according to the disclosure accordingly provides for monitoring the actual pressure and/or the actual flow rate of the immersion medium introduced under a predetermined pressure and/or with a predetermined flow rate into the at least one interspace, to the effect of whether a change in the actual pressure and/or the actual flow rate with respect to the predetermined pressure and/or the predetermined flow rate is established.

In some embodiments, the at least one first interspace is arranged between the light-sensitive surface and a surface of the projection objective which faces the surface.

The monitoring of the actual pressure and/or of the actual flow rate in the interspace between the substrate and the projection objective makes it possible, then, to counteract the pulsating pressure and/or flow rate changes caused by the stepwise movement of the substrate relative to the projection objective via suitable measures.

Such measures may involve a setting or readjustment of the actual pressure and/or of the actual flow rate of the immersion liquid via at least one setting unit depending on the detected deviations of the actual pressure and/or of the flow rate to the predetermined pressure and/or the predetermined flow rate in order to keep the predetermined pressure and/or the predetermined flow rate as constant as possible during the exposure process.

For this purpose, the projection exposure apparatus can be equipped with a setting unit for setting the pressure and/or the flow rate of the immersion medium.

In certain embodiments, the method provides for the monitoring of the actual pressure and/or of the actual flow rate of the immersion medium to be effected during the stepwise movement of the substrate.

In the case of these measures, the state changes of the immersion medium that are caused by the stepwise movement of the substrate are accordingly combated by acting on the immersion medium itself. Thus, by way of example, the pressure can be increased or decreased or the flow rate can be increased or decreased in order in this way for example for a change in the position of a terminating element or of an end face of the projection objective in the direction of the optical axis to be kept as small as possible or even avoided.

The monitoring device of the projection exposure apparatus can have a pressure gauge and/or a flow rate meter, which are/is arranged for example in a feed line for the immersion medium into the at least first interspace in particular between the substrate and the terminating element of the projection objective, but can also be arranged in the interspace itself.

In association with the configuration according to which the projection exposure apparatus has a setting unit for setting the pressure and/or the flow rate of the immersion medium, the pressure gauge and/or the flow rate meter can be coupled to the setting unit, whereby an automatic control loop is provided which advantageously does not involve manual intervention.

Another measure for avoiding a pulsating change in the position of the terminating element or of the end face of the projection objective which is caused by the stepwise movement of the substrate relative to the projection objective, and thus causes imaging aberrations can involve positionally adjusting the end face of the projection objective in the direction of the optical axis via at least one actuator depending on the detected deviations of the pressure and/or of the flow rate into a position which comes as close as possible to a desired position of the end face which is assigned to the predetermined pressure and/or the predetermined flow rate.

In the projection exposure apparatus, correspondingly a terminating element of the projection objective which has the end face of the projection objective can be moved in the direction of the optical axis, and the terminating element is assigned at least one actuator coupled to the monitoring device for the actual pressure and/or the actual flow rate.

This measure does not involve reacting to the changes in the actual pressure and/or in the actual flow rate in the interspace between the substrate and the projection objective by acting on the immersion medium itself, rather the end face or the terminating element of the projection objective which has the end face is kept positionally fixed via piezo electric actuators, for example, in order that the pulsating change in the imaging properties which is caused by the stepwise movement of the substrate is kept as small as possible or even avoided.

With regard to the monitoring of the actual pressure and/or of the flow rate, various procedures can be adopted in the method according to the disclosure.

In some embodiments, the changes in the pressure and/or in the flow rate which result during the stepwise movement of the substrate can be detected anew during a respective exposure operation of the projection exposure apparatus.

This procedure has the advantage that system parameters which change from exposure operation to exposure operation are always concomitantly taken into account in the monitoring of the actual pressure and/or of the actual flow rate. Consequently, it is not necessary to ensure that the operating conditions under which the projection exposure apparatus is operated as far as possible do not change.

In certain embodiments, the procedure can also be such that the changes in the pressure and/or in the flow rate which result (e.g., during the stepwise movement) are detected during a calibration operation of the projection exposure apparatus and are stored in assignment to position and speed data of the stepwise movement of the substrate in an electronic memory.

The data stored in the electronic memory can then be retrieved from the memory during each exposure operation of the projection exposure apparatus, and it is then possible to dispense with a respective current monitoring of the actual pressure and/or of the actual flow rate of the immersion medium during each exposure operation.

The data or to put it more precisely data pairs including pressure and/or flow rate changes and the associated position and speed data of the stepwise movement of the substrate, stored in the electronic memory can then be used to control the setting unit—already mentioned above—for the pressure and/or the flow rate of the immersion medium or the at least one actuator for positionally adjusting the terminating element or the end face of the projection objective.

In this connection the projection exposure apparatus can have an electronic memory coupled to the stepper drive for the table of the substrate, wherein the stepper drive is then coupled to the setting unit for setting the pressure and/or the flow rate, or to the at least one actuator for positionally adjusting the terminating element.

In some embodiments, the end face of the projection objective is provided with a coating which is repellent with respect to the immersion liquid.

The adhesion of the immersion medium at the end face is one reason, inter alia, why a change in the pressure and/or the flow conditions in the interspaces between the substrate and the projection objective is established during the stepwise movement of the substrate relative to the projection objective.

The adhesion of the immersion medium, for example water, and thus the resulting pressure and flow changes in the interspace between the substrate and the projection objective are reduced by the coating of the end face with a hydrophobic substance, for example.

A further aspect of the disclosure provides a method for setting an optical imaging property of a projection objective in a microlithographic projection exposure apparatus via which a mask can be imaged onto a substrate having a light-sensitive surface, wherein the substrate can be moved stepwise in a direction transversely with respect to an optical axis relative to a projection objective, including the steps of:
introducing an immersion medium into at least one first interspace, wherein the at least one first interspace—as seen along the optical axis—is always arranged within an illumination system and/or the projection objective and/or between the illumination system and the mask and/or the mask and the projection objective and/or the projection objective and the substrate, and/or is arranged between the light-sensitive surface and an end face of the projection objective which faces the surface, and
setting a pressure and/or a flow rate of the immersion medium in such a way that the optical imaging property comes as close as possible to a desired imaging property.

A further aspect of the present disclosure provides a microlithographic projection exposure apparatus for imaging a mask onto a substrate having a light-sensitive surface, including a projection objective, a table, on which can be arranged the substrate with the light-sensitive surface facing an end face of the projection objective, including a stepper drive for the stepwise movement of the table in a direction transversely with respect to an optical axis of the projection objective, including an at least first interspace into which an immersion medium can be introduced, wherein the at least one first interspace—as seen along the optical axis—is always arranged within an illumination system and/or the projection objective and/or between the illumination system and the mask and/or the mask and the projection objective and/or the projection objective and the substrate, and/or can be arranged between the light-sensitive surface and an end face of the projection objective which faces the surface, and a setting unit is provided for setting a pressure and/or the flow rate of the immersion medium in order to set an optical imaging property of the projection objective to a desired imaging property.

The immersion medium can be at least one immersion liquid and/or at least one immersion gas.

In the method mentioned above and the projection exposure apparatus mentioned above, a settability of the pressure and/or of the flow rate of the immersion medium in the at least one first interspace is advantageously used to alter an optical imaging property in the projection exposure apparatus, but in particular the projection objective, in a targeted manner. In particular a change in the pressure and/or in the flow rate in the interspace between the substrate and the projection objective can namely be used to set the position of the terminating element or the end face of the projection objective in the direction of the optical axis in a targeted manner in order to set a specific optical imaging property of the projection objective, for example to correct a rotationally symmetrical imaging aberration ascertained, such as a spherical aberration.

Further interspaces can advantageously be arranged, as seen along the optical axis, in the illumination device, between illumination device and mask, in the projection objective, between mask and projection objective, and between projection objective and the substrate surface to be exposed. In this case, each of the interspaces is provided with a separate immersion media flushing circuit. Each immersion media flushing circuit has a separate inlet and a separate outlet. The flow rate and/or the pressure of the immersion medium can be controlled and regulated separately in each case. However, it is also possible to control and regulate different immersion media circuits in a manner dependent on one another, in particular in order to save control and regulating units in the projection exposure apparatus.

The parameters of temperature, pressure, flow rate, refractive index, purity, absorption are available for control and for settability of the immersion media flushing circuits. The immersion medium itself can be provided with additives for lowering the surface tension, with additives for setting the refractive index, with additives for protecting the delimiting surfaces. Furthermore, the immersion media flushing circuit can have an ultrasonic unit and a cleaning unit, for example a filter.

Devices for setting the parameters of temperature, pressure, flow rate, refractive index, absorption and purity in a targeted manner can likewise be incorporated into each immersion media flushing circuit.

The devices for setting the abovementioned parameters in a targeted manner are not specifically discussed here since they generally involve standard devices, such as e.g. temperature-regulating devices or metering devices for introducing additives.

The method mentioned above and the projection exposure apparatus mentioned above can, however, be used not just by themselves but also in combination with the previously described method and the previously described projection exposure apparatus with which imaging aberrations which are caused generally on account of stepwise movement of the substrate relative to the projection objective and are established in pulsating fashion can be corrected.

Further advantages and features will become apparent from the following description and the accompanying drawing.

It goes without saying that the features mentioned above and those yet to be explained below can be used not only in the combination respectively specified but also in other combinations or by themselves without departing from the scope of the present disclosure.

### BRIEF DESCRIPTION OF THE DRAWINGS

Exemplary embodiments of the disclosure are illustrated in the drawing and are described in more detail below with reference to the drawings, in which:

FIG. 1 shows a schematic overall illustration of a microlithographic projection exposure apparatus in a side view;

FIG. 2 shows an enlarged excerpt in the region A in FIG. 1 with further details of the projection exposure apparatus; and

FIG. 3 shows an illustration similar to FIG. 2 of the excerpt A in FIG. 1 in accordance with a further exemplary embodiment; and

FIG. 4 shows an exemplary embodiment of a projection exposure apparatus having three interspaces.

### DETAILED DESCRIPTION

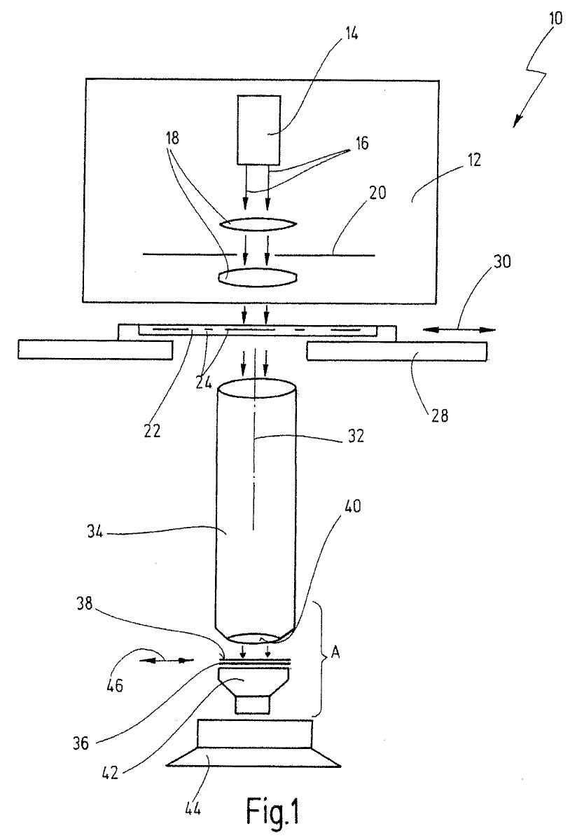

A microlithographic projection exposure apparatus provided overall with the general reference 10 is illustrated generally schematically in FIG. 1.

The projection exposure apparatus 10 has an illumination system 12, which has an exposure source 14, for example a laser, for generating a light beam 16, an illumination optical assembly 18 and a diaphragm 20, wherein the illumination optical assembly 18 and the diaphragm 20 only represent a highly simplified and exemplary configuration of the illumination system 12.

A mask 22 is disposed downstream of the illumination system 12 in the direction of propagation of the light beam 16, the mask 22, as indicated by 24, being provided with a patterning. The mask 22, which is also referred to as a reticle, is fixed on a holder 28, wherein the holder 28 and thus the mask 22 can be moved in a direction transversely with respect to an optical axis 32 in accordance with a double-headed arrow 30. The holder 28 together with the mask 22 can be moved via a drive (not illustrated).

Further in the direction of propagation of the light beam 16, a projection objective 34 is disposed downstream of the mask 22. The projection objective 34 has a plurality of optical components (not illustrated more specifically). The optical components can be of exclusively refractive type, of exclusively reflective type, or a combination of refractive and reflective components.

Via the projection objective 34, the mask 22, to put it more precisely the patterning 24 thereafter is imaged onto a substrate 36 having a light-sensitive surface 38, which is formed for example by a photoresist applied on the substrate 36. The light-sensitive surface 38 of the substrate 36 faces an end face 40 of the projection objective 34.

The light-sensitive surface 38 is not necessarily the topmost outer layer of the substrate 36. It can be covered for example by at least one antireflection layer (not illustrated).

The substrate 36 is arranged on a table 42, which can be moved on a base 44 relative to the projection objective 34 in a direction transversely with respect to the optical axis 32 in accordance with a double-headed arrow 46.

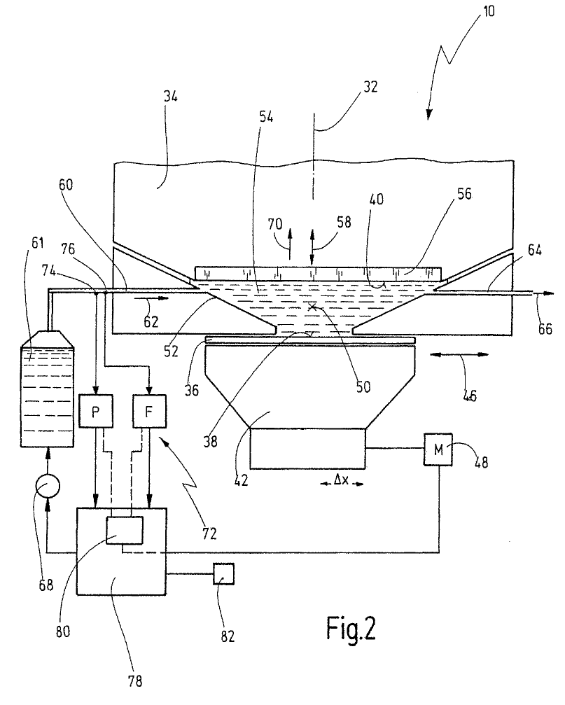

FIG. 2 shows an exemplary embodiment of a projection exposure apparatus with an interspace 50. An immersion medium, here an immersion liquid, is filled into the interspace 50. However, an immersion gas or a mixture of immersion liquid and/or immersion gas and a combination of different immersion liquids and/or immersion gases can also be involved. The one interspace 50 is illustrated by way of example here, but a plurality of interspaces which are separated from one another can also be involved.

FIG. 2 illustrates a corresponding stepper motor 48 for the stepwise movement of the table 42 and thus of the substrate 36.

In the microlithographic production of electronic components, for example integrated circuits, the substrate 36 is also referred to as a wafer.

FIG. 2 furthermore illustrates that the interspace 50 is present between the end space 40 of the projection objective 34 and the light-sensitive surface 38 of the substrate 36, which interspace, in the exemplary embodiment shown, is delimited laterally by a wall element 52 tapering conically towards the surface 38 of the substrate 36. The immersion medium, here the immersion liquid 54, for example water, can be introduced into the interspace 50. The extension of the interspace 50 in the direction of the optical axis 32 is in the region of a few millimetres. The immersion liquid 54 touches both the end face 40 of the projection objective 34 and the light-sensitive surface 38 of the substrate 36.

The end face 40 of the projection objective 34 is more precisely the end face of an optical element 56 which, in the exemplary embodiment shown, is formed as a plane-parallel terminating plate, which can be produced for example from quartz glass or fluorite. The end face 40 is provided with a coating that is repellent with respect to the immersion liquid.

Owing to the construction, the terminating element 56 is suspended, for example resiliently, such that it can move at least infinitesimally in the direction of a double-headed arrow.

During the exposure operation of the projection exposure apparatus 10, the light beam 16 generated by the light source 14 passes through the mask 22 and through the projection objective 34, such that the patterning 24 of the mask 22 is imaged onto the light-sensitive surface 38 of the substrate 36 via the projection objective 34. In order to image the entire area of the mask 22 on the light-sensitive surface 38, the mask 22 is illuminated in a “scan” process. In this case, the entire region of the mask 22 is illuminated in a scanning fashion by the mask 22 being moved through the light beam 16 delimited by the diaphragm 20. The table 42 with the substrate 36 thereon is moved stepwise with the aid of a stepper motor 48 during the exposure, in order to progressively expose the entire surface 38 of the substrate 36 via the light beam 16.

The immersion liquid 54 is introduced into the interspace 50 via a feed line 60 from a reservoir 61 in the direction of an arrow 62 and is discharged again from the interspace 50 via a discharge line 64 in the direction of an arrow 66, the discharged immersion liquid being fed to the reservoir 61 again via a circuit that is not illustrated more specifically.

In the reservoir 61, the temperature of the immersion liquid 54 can be conditioned, as described in the document WO 2004/053596 A2.

Via a pump 68, the immersion liquid 54 is introduced into the interspace 50 from the reservoir 61 under a predetermined pressure and with a predetermined flow rate and correspondingly flows through the interspace under the predetermined pressure and with the predetermined flow rate.

In the phases of the exposure operation in which the substrate 36 stands still, the pressure and flow conditions of the immersion liquid 54 in the interspace 50 do not change with respect to the predetermined pressure and the predetermined flow rate.

If the substrate 36 is then moved by a distance Δx in the direction of the double-headed arrow 46, for example towards the left in FIG. 2, in order to carry out a next scanning step, the pressure and flow conditions of the immersion liquid 54 within the interspace 50 change on account of this movement process, even though the immersion liquid 54 is still fed to the interspace 50 under the predetermined pressure and with the predetermined flow rate. It is to be assumed that these changes in the pressure and flow conditions in the interspace 50 during the movement of the substrate 36 are based on the fact that the immersion liquid 54 exhibits a certain adhesion to the end face 40 and a certain adhesion to the surface 38.

During the movement of the substrate 36, the pressure of the immersion liquid 54 in the interspace 50 can momentarily increase for example on account of the movement, the increased pressure having the effect that the end face 40 of the terminating element 56 is raised, albeit only very slightly, in the direction of an arrow 70. However, the distance between the end face 40 and the surface 38 and also the distance between the terminating element 56 and the penultimate optical element (not illustrated) of the projection objective 34 thus change, which adversely influences the imaging properties of the projection objective 34. As soon as the substrate 36 stands still again after the movement step, the predetermined pressure and flow conditions of the immersion liquid 54 in the interspace 50 are established again, whereby the imaging aberration induced by the movement disappears again if the projection objective 34 is free of imaging aberrations in the stationary state of the table 42.

Since the substrate 36 is moved stepwise repeatedly during an exposure operation of the projection exposure apparatus 10, imaging aberrations therefore occur temporarily or in pulsating fashion during the exposure of the surface 38.

The following measures are taken in the projection exposure apparatus 10 in order to counteract the above-described adverse effects of the stepwise movement of the substrate 36 on the optical imaging property of the projection objective 34.

For this purpose, the projection exposure apparatus has at least one monitoring device 72 for monitoring an actual pressure and/or an actual flow rate of the immersion liquid 54 in the interspace 50.

The monitoring device 72 can have a pressure gauge 74 and/or a flow rate meter 76, which are arranged in the feed line 60 for the immersion liquid 54, as is illustrated in FIG. 2. However, the pressure gauge 74 and/or the flow rate meter 76 can also be arranged in the interspace 50 itself.

Furthermore, the projection exposure apparatus 10 has a setting unit 78 for setting the pressure and/or the flow rate of the immersion liquid 54, which is coupled to the monitoring device 72, on the one hand, and to the pump 68, on the other hand via signal lines.

Via the monitoring device 72, it is then possible to detect deviations—resulting during the stepwise movement of the substrate 36—of the actual pressure and/or of the actual flow rate of the immersion liquid 54 in the interspace 50 from the predetermined pressure and/or the predetermined flow rate during a respective exposure operation of the projection exposure apparatus 10, at least during the stepwise movement of the substrate 36. The detection data are evaluated and fed to the setting unit 78, which, in the case of detection of a pressure and/or flow rate change, then correspondingly drives the pump 68 in order to counteract these pressure and/or flow rate changes by an increase or decrease in the pump power, such that as far as possible the predetermined and pressure and the predetermined flow rate are maintained in the interspace 50.

As an alternative to the procedure of detecting changes in the actual pressure and/or in the actual flow rate of the immersion liquid 54 in the interspace 50 via the monitoring device 72 during each exposure operation of the projection exposure apparatus 10, it is possible, via the monitoring device 72, to detect the changes—which result during the stepwise movement—in the pressure and/or in the flow rate during a calibration operation of the projection exposure apparatus and to store them in assignment to position and speed data of the stepwise movement of the substrate 36 in an electronic memory 80. The position and speed data of the stepwise movement of the substrate 36 can be supplied by the stepper motor 48 of the table 42.

During an exposure operation of the projection exposure apparatus 10, it is then not necessary for changes in the actual pressure and/or in the actual flow rate of the immersion liquid 54 to be detected permanently via the monitoring device 72. Rather, the increase or decrease in the pressure and/or in the flow rate of the immersion liquid 54 can then be realized by a direct coupling between the stepper motor 48 and the setting unit 78. With respect to each position and speed of the table 42 and thus of the substrate 36, the electronic memory 80 contains a corresponding actuating signal for controlling the pump 68 in order to counteract the pressure fluctuations and/or flow rate changes in the interspace 50.

The measures described above serve to counteract the above-described pulsating or pump-like changes in the optical imaging property of the projection objective 34. The optical imaging property which is regulated in this way is, in particular, a spherical aberration that occurs if the terminating element 56 and thus the end face 40 thereof moves in the direction of the double-headed arrow 58 on account of the pressure fluctuations.

In accordance with a further measure, however, it is possible, via the setting unit 78, to set an optical imaging property in a targeted manner by increasing or decreasing the pressure and/or the flow rate in order to obtain a desired imaging property of the projection objective 34. For this purpose, in the setting unit 78 an external manipulation device 82 is provided, which is coupled to the setting unit 78, in order to set a predetermined pressure and/or a predetermined flow rate of the immersion liquid 54 in the interspace 50 in such a way that the desired imaging property that is wanted is as far as possible achieved. Specifically, via a pressure and/or flow rate setting, it is possible to position the position of the terminating element 56 in the direction of the optical axis 32 in such a way that the desired imaging property is achieved, for example a spherical aberration is corrected by positioning the terminating element 56.

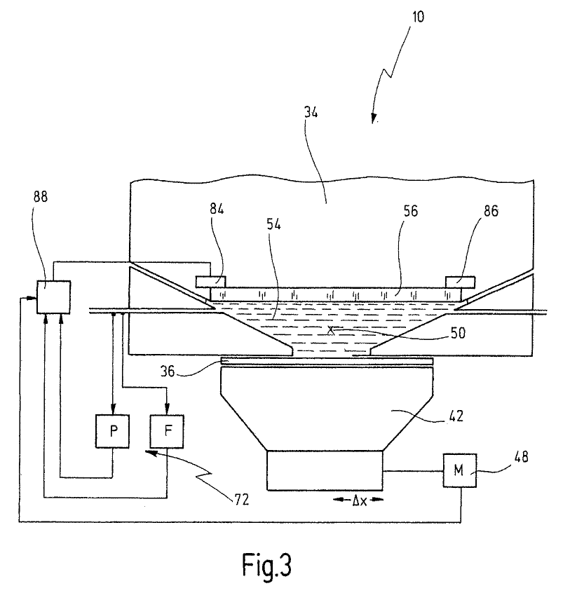

FIG. 3 illustrates an exemplary embodiment that is modified relative to FIG. 2, wherein identical or comparable parts and elements of the projection exposure apparatus 10 are provided with the same reference symbol as in FIG. 2. Only the differences with respect to the exemplary embodiment of FIG. 2 are described below.

This exemplary embodiment, too, includes the monitoring device 72 for monitoring the actual pressure and/or the actual flow rate of the immersion liquid 54 in the interspace 50, which monitoring device detects changes—caused during the stepwise movement of the substrate 36—in the actual pressure and/or in the actual flow rate of the immersion liquid 54 in the interspace 50.

In contrast to the previous exemplary embodiment, now such changes in the actual pressure and/or in the actual flow rate are not counteracted by increasing and/or decreasing the pressure or the flow rate of the immersion liquid 54 itself, rather the terminating element 56 is connected to actuators 84, 86 arranged in a manner distributed over the periphery, two of the actuators being illustrated in FIG. 3. There can also be more or fewer of such actuators present in a manner distributed over the periphery on the terminating element 56.

The actuators 84 and 86, as is illustrated only for the actuator 84 in FIG. 3, are coupled to the monitoring device 72 via a control device 88. Changes in the actual pressure and/or in the actual flow rate of the immersion liquid 54 in the interspace 50 which are detected by the monitoring device 72 are forwarded by the monitoring device 72 to the control device 88 in the form of control signals, via which the control device 88 then controls the actuators 84 and 86 in such a way that the terminating element 56 is held in position in an unchanged fashion during the stepwise movement of the substrate 36. Consequently, changes in the actual pressure and/or in the actual flow rate which are caused by the stepwise movement do not affect a change in the position of the terminating element 56, as a result of which the desired imaging property that is wanted for the projection objective 34 is not altered.

The changes in the actual pressure and/or in the actual flow rate of the immersion liquid 54 in the interspace 50 can again be detected during a respective exposure operation of the projection exposure apparatus 10 or beforehand in a calibration operation thereof. For the latter case there can be a coupling between the stepper motor 48 and the control device 88, such that the control device 88 controls the actuators 84, 86 during an exposure operation of the projection exposure apparatus 10 solely on the basis of position and speed data supplied by the stepper motor 48.

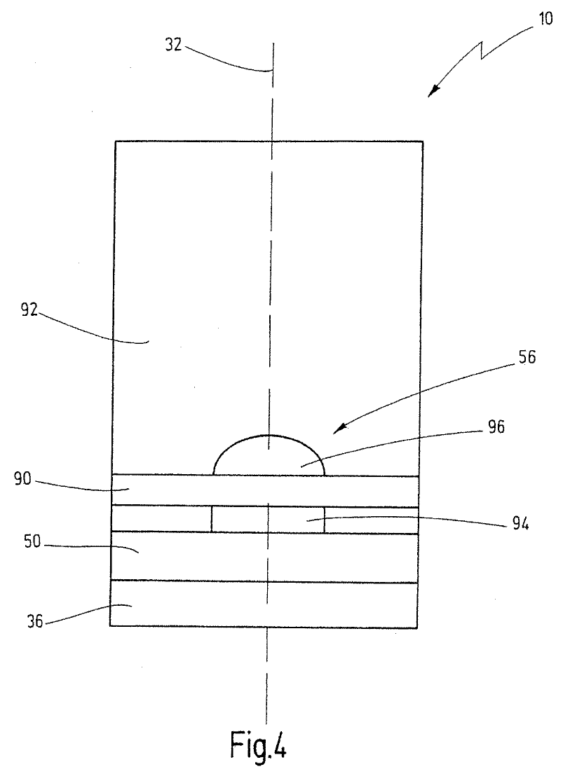

FIG. 4 shows an exemplary embodiment of the arrangement of three interspaces in the projection exposure apparatus. Identical parts are provided with the same reference numerals as in FIGS. 2 and 3. In addition to the interspace 50 arranged between the exposure-sensitive surface of the substrate and the end face of the last optical component of the projection objective, a second interspace 90 and a third interspace 92 are shown in the exemplary embodiment.

The optical terminating element 56 is subdivided into a first optical element 94 and a second optical element 96. The second interspace 90 is arranged between the first element 94 and the second element 96 of the terminating element 56 and the third interspace 92 is arranged above, that is to say as seen in the direction of the illumination unit along the optical axis 32.

The first interspace 50, the second interspace 90 and the third interspace 92 are in each case flushed with an immersion medium, wherein different immersion liquids and/or different immersion gases can be used. It is possible, for example, to flush the third interspace 92 with an immersion gas and to flush the other two interspaces 90 and 50 with immersion liquids, wherein a combination of different immersion liquids can also be involved.

The illustration does not show the immersion media flushing circuit, called flushing circuit for short, which generally has an outlet and an inlet. Each of the interspaces 50, 90 and 92 illustrated has a separate flushing circuit. In particular, the flushing circuits are hermetically sealed in order to prevent different immersion media from mixing together.

In this case, it is provided that each flushing circuit can be controlled and regulated separately. This means that in each flushing circuit the pressure and/or the feed rate for the immersion medium and/or the temperature, and/or the composition of the respective flushing medium can be supervised and set, i.e. controlled, separately.

In this case, provision is likewise made for providing e.g. the immersion liquids with addition of additives with different chemical compositions in order e.g. to influence the surface tension and/or the refractive index. Provision is likewise made for providing additives for protecting the surfaces adjoining the immersion medium.

It is likewise possible to monitor and regulate different flushing circuits jointly in order that the number of control and regulator units is kept small.

Cleaning units, e.g. filters, and ultrasonic units can likewise be provided in the flushing circuits.

The geometry, i.e. the form of the interspaces 50, 90 and 92 is only illustrated schematically in FIG. 4, wherein different geometries, in particular adapted to the surface of the optical elements, can be provided for the interspaces.

The interspaces, which can be provided at different locations in the projection exposure apparatus, can be arranged according to a plurality of principles. Firstly, it is possible for optical elements of the illumination unit and/or of the projection objective in each case to be provided with interspaces from both sides, wherein identical and/or different immersion media can be filled into the interspaces above and below the respective optical component.

Secondly, it is possible e.g. to provide one interspace in the illumination unit 12 and to arrange a second interspace between the light-sensitive topside of the substrate 36 and that surface of the last optical component 56 which faces the substrate.

Interspaces can furthermore be provided between the illumination unit 12 and the mask and also between optical components of the projection objective.

The division of the terminating element 56 is advantageous in particular because the intrinsic birefringents can thus be compensated for.

Optionally, all the interspaces 50, 90 and 92 and the associated flushing circuits are hermetically sealed in order to reliably keep the immersion medium in the interspaces and to prevent different immersion media from mixing together.

What is claimed is:

1. A method, comprising:
introducing an immersion medium into a first interspace of a microlithographic projection exposure apparatus, the immersion medium being introduced with at least one predetermined parameter selected from the group consisting of a predetermined pressure of the immersion medium in the first interspace and a predetermined flow rate of the immersion medium in the first interspace; and
monitoring at least one actual parameter to determine a deviation from the at least one predetermined parameter, the at least one actual parameter being selected from the group consisting of an actual pressure of the immersion medium in the first interspace and an actual flow rate of the immersion medium in the first interspace.

2. The method of claim 1, wherein the first interspace is arranged between a light-sensitive surface and an end face of the microlithographic projection objective which faces the light-sensitive surface.

3. The method of claim 1, wherein a deviation of the at least one actual parameter is detected anew during an exposure operation of the microlithographic projection exposure apparatus.

4. The method of claim 1, wherein a deviation of the at least one actual parameter is detected during a calibration operation of the microlithographic projection exposure apparatus and is stored in assignment to position and speed data of the movement of the substrate in an electronic memory.

5. The method of claim 1, further comprising setting the at least one actual parameter via at least one setting unit depending on a detected deviation of the at least one actual parameter from the at least one predetermined parameter.

6. The method of claim 1, further comprising adjusting a position of an end face of the projection objective in a direction of an optical axis of the microlithographic projection exposure apparatus via at least one actuator depending on a detected deviation of the at least one actual parameter toward a desired position of the end face which is assigned to the at least one predetermined parameter.

7. The method of claim 5, wherein a deviation of the at least one actual parameter is detected during a calibration operation of the microlithographic projection exposure apparatus and is stored in assignment to position and speed data of a movement of a substrate in an electronic memory, and wherein the at least one setting unit sets the at least one actual parameter during an exposure operation on the basis of the position and speed data stored in the electronic memory.

8. The method of claim 6, wherein a deviation of the at least one actual parameter is detected during a calibration operation of the microlithographic projection exposure apparatus and is stored in assignment to position and speed data of the movement of the substrate in an electronic memory, and the at least one actuator sets the end face of the projection objective during an exposure operation on the basis of the position and speed data stored in the electronic memory.

9. The method of claim 1, wherein the immersion medium is introduced into the first interspace via at least one inlet and the immersion medium is discharged from the first interspace via at least one outlet so that a closed immersion medium circuit is present for the first interspace.

10. The method of claim 9, wherein:
a second interspace is arranged within the microlithographic projection exposure apparatus;
an immersion medium is introduced into the second interspace via a second inlet;
the immersion medium is discharged from the second interspace via a second outlet so that a closed immersion medium circuit is present for the second interspace; and
pressure of the immersion medium and/or flow rate of immersion medium is set separately in the first and second immersion interspaces.

11. The method of claim 1, wherein the immersion medium comprises at least one medium selected from the group consisting of an immersion liquid and an immersion gas.

12. The method of claim 1, wherein a plurality of interspaces are arranged in the microlithographic projection exposure apparatus, into which at least one immersion medium is introduced.

13. The method of claim 1, wherein at least one interspace is arranged at optical components of at least one of an illumination unit and the projection objective, which optical components are adjacent or arranged at a distance along the optical axis.

14. The method of claim 1, wherein monitoring of the at least actual parameter is effected during movement of the substrate.

15. A method, comprising:
introducing an immersion medium into a first interspace of a microlithographic projection exposure apparatus; and
setting at least one parameter of the immersion medium based on a desired imaging property of the microlithographic projection exposure apparatus, the at least one parameter of the immersion medium being selected from the group consisting of a pressure of the immersion medium in the first interspace and a flow rate of the immersion medium in the first interspace.

16. The method of claim 15, wherein the immersion medium is introduced into the first interspace via an inlet, and the immersion medium is discharged from the interspace via an outlet so that a closed immersion medium circuit is present for the first interspace.

17. The method of claim 16, wherein:
a second interspace is arranged within the microlithographic projection exposure apparatus;
an immersion medium is introduced into the second interspace via a second inlet;
the immersion medium is discharged from the second interspace via a second outlet so that a closed immersion medium circuit is present for the second interspace; and
pressure and/or flow rate of immersion medium is set separately in the first and second immersion interspaces.

18. The method of claim 15, wherein the immersion medium comprises at least one medium selected from the group consisting of an immersion gas and an immersion liquid.

19. The method of claim 15, wherein a plurality of interspaces are arranged in the microlithographic projection exposure apparatus, into which at least one immersion medium is introduced.

20. The method of claim 15, wherein at least one interspace is arranged at optical components of at least one of an illumination unit and the projection objective, which optical components are adjacent or arranged at a distance along the optical axis.

21. An apparatus, comprising:
an illumination unit;
a projection objective;
a table on which can be arranged a substrate with a light-sensitive surface facing an end face of the projection objective;
a drive configured to move the table in a direction transversely with respect to an optical axis of the projection objective;
an interspace into which an immersion medium can be introduced; and
at least one monitoring device configured to monitor at least one actual parameter of the immersion medium, the at least one actual parameter of the immersion medium being selected from the group consisting of an actual pressure of the immersion medium in the interspace and an actual flow rate of the immersion medium in the interspace,
wherein the apparatus is a microlithographic projection exposure apparatus.

22. The projection exposure apparatus of claim 21, wherein the monitoring device comprises a pressure gauge and a flow rate meter.

23. The projection exposure apparatus of claim 22, wherein at least one element selected from the group consisting of the pressure gauge and the flow rate meter is arranged in a feed line for the immersion medium into the at least one first interspace.

24. The projection exposure apparatus of claim 21, comprising a setting device configured to set the at least one actual parameter of the immersion medium.

25. The projection exposure apparatus of claim 24, wherein the monitoring device is coupled to the setting device.

26. The projection exposure apparatus of claim 21, wherein the first interspace is arranged between the light-sensitive surface of the substrate and the end face of the projection objective.

27. The projection exposure apparatus of claim 21, further comprising a second interspace.

28. The projection exposure apparatus of claim 27, further comprising further interspaces.

29. The projection exposure apparatus of claim 21, wherein the first interspace is capable of being arranged on a substrate facing side or a substrate-remote side of an optical element of the illumination unit and/or the projection objective.

30. The projection exposure apparatus of claim 27, wherein the first and second interspaces are arranged, as seen along the optical axis, in a manner adjoining both sides of an optical component of at least one of the illumination unit and the projection objective.

31. The projection exposure apparatus of claim 27, wherein the first and second interspaces are arranged on both sides in a manner adjoining different optical components of at least one of the illumination unit and the projection objective.

32. The projection exposure apparatus of claim 21, wherein a terminating element of the projection objective which has the end face of the projection objective and can be moved in the direction of the optical axis, and wherein the terminating element is assigned at least one actuator coupled to the monitoring device.

33. The protection exposure apparatus of claim 21, comprising an electronic memory in which a deviation, which can be detected during a calibration operation of the projection exposure apparatus, of at least one actual parameter from at least one predetermined parameter of the immersion medium, the at least one actual parameter being selected from the group consisting of an actual flow rate of the immersion medium and an actual pressure of the immersion medium.

34. The projection exposure apparatus of claim 33, wherein the electronic memory is coupled to the drive.

35. The projection exposure apparatus of claim 24, wherein the drive is coupled to the setting unit.

36. The projection exposure apparatus of claim 32, wherein the drive is coupled to the at least one actuator.

37. The projection exposure apparatus of claim 21, wherein the end face of the projection objective is provided with a coating that repels the immersion medium.

38. The projection exposure apparatus of claim 21, wherein the immersion medium comprises at least one medium selected from the group consisting of an immersion liquid and an immersion gas.

39. The projection exposure apparatus of claim 27, wherein the first and second interspaces have different geometries.

40. The projection exposure apparatus of claim 27, wherein the first and second interspaces have separate inlets and separate outlets for the respective immersion medium, which respectively form a closed immersion medium circuit in each case.

41. The projection exposure apparatus of claim 40, wherein each of the immersion media circuits can be controlled and regulated separately.

42. The projection exposure apparatus of claim 21, wherein the first interspace is hermetically tight.

43. The projection exposure apparatus of claim 40, wherein each of the immersion media circuits is hermetically tight.

44. The projection exposure apparatus of claim 21, wherein a of the at least one actual parameter is due to a stepwise movement of the substrate.

45. An apparatus, comprising:
an illumination unit;
a projection objective;
a table on which can be arranged the substrate with the light-sensitive surface facing an end face of the projection objective;
a drive configured to move the table in a direction transversely with respect to an optical axis of the projection objective;
a first interspace wherein an immersion medium can be introduced into the at least one first interspace; and
a setting unit configured to set at least one parameter of the immersion medium to set an optical imaging property in the projection exposure apparatus to a desired imaging property, the at least one parameter of the immersion medium being selected from the group consisting of a pressure of the immersion medium in the first interspace and a flow rate of the immersion medium in the first interspace,
wherein the apparatus is a microlithographic protection exposure apparatus.

46. The projection exposure apparatus of claim 45, wherein the optical imaging property is a magnitude of a spherical aberration.

47. The projection exposure apparatus of claim 45, wherein the end face of the projection objective is provided with a coating that repels the immersion medium.

48. The projection exposure apparatus of claim 45, wherein at least one second interspace is provided.

49. The projection exposure apparatus of claim 48, wherein further interspaces are provided.

50. The projection exposure apparatus of claim 45, wherein the immersion medium comprises at least one medium selected from the group consisting of an immersion liquid and an immersion gas.

51. The projection exposure apparatus of claim 48, wherein the first and second interspaces have different geometries.

52. The projection exposure apparatus of claim 48, wherein the first and second interspaces have separate inlets and separate outlets for the respective immersion medium, which respectively form a closed immersion medium circuit in each case.

53. The projection exposure apparatus of claim 52, wherein each of the immersion media circuits can be controlled and regulated separately.

54. The projection exposure apparatus of claim 45, wherein the first interspace is hermetically tight.

55. The projection exposure apparatus of claim 52, wherein each of the immersion media circuits is hermetically tight.
